(19) United States
(12) Patent Application Publication
(10) Pub. No.: US 2002/0022568 A1
(43) Pub. Date: Feb. 21, 2002

(54) Ceramic membranes for use in catalytic membrane reactors with high ionic conductivities and improved mechanical properties

(76) Inventors: Richard Mackay, Lafayette, CO (US); Anthony F. Sammells, Boulder, CO (US)

Correspondence Address: GREENLEE WINNER AND SULLIVAN P C, 5370 MANHATTAN CIRCLE, SUITE 201, BOULDER, CO, 80303, US

(21) Appl. No.: 09/905,651

(22) Filed: Jul. 13, 2001

Related U.S. Application Data
(63) Continuation-in-part of application No. 09/748,344, filed on Dec. 22, 2000.
Application No. 09/748,344 is a continuation-in-part of application No. 09/286,829, filed on Apr. 6, 1999, now Pat. No. 6,165,431.
Application No. 09/286,829 is a continuation-in-part of application No. 08/639,781, filed on Apr. 29, 1996, now Pat. No. 6,033,632.
Application No. 08/639,781 is a continuation-in-part of application No. 08/163,620, filed on Dec. 8, 1993, now abandoned.

(51) Int. Cl. B01J 23/10; C01B 3/26; C04B 35/50

(52) U.S. Cl. 501/152; 423/263; 423/593; 422/129; 423/651

(57) ABSTRACT

Ceramics of the composition:

Ln₁₋ₓSr_{y}Ca_{x-y}MO_{3-δ}

where Ln is an element selected from the f block lanthanides and yttrium or mixtures thereof; M is an element selected from the d block transition metals or mixtures thereof; 0.1≦x≦0.4; 0.01≦y≦0.25 and δ is a number that varies to maintain charge neutrality are provided along with methods of their use. These ceramics are useful in making and using gas-impermeable ceramic membranes that exhibit high electronic and ionic conductivity, low coefficients of expansion and high chemical and thermal stability under catalytic membrane reactor conditions. The ceramics provided are particularly useful for promotion of oxidation-reduction reactions and for separating molecular oxygen from oxygen containing gases.

### CROSS REFERENCE TO RELATED APPLICATIONS

This application is a continuation-in-part of Application Ser. No. 09/748,344 filed Dec. 22, 2000, which is a continuation-in-part of Application Ser. No. 09/286,829, filed Apr. 6, 1999 (now U.S. Pat. No. 6,165,431), which is a continuation-in-part of Application Ser. No. 08/639,781 filed Apr. 29, 1996 (now U.S. Pat. No. 6,033,632), which is a continuation-in-part of Application Ser. No. 08/163,620 filed Dec. 8, 1993, now abandoned.

### STATEMENT REGARDING FEDERALLY SPONSORED RESEARCH OR DEVELOPMENT

This invention was made at least in part with funding from the United States Department of Energy Grant No. DE-FG02-94ERB1750. The United States Government has certain rights in this invention.

### BACKGROUND OF THE INVENTION

This invention relates to ceramic materials that are mixed ionic and electron conductors useful in manufacture of dense non-porous membranes for catalytic reactors which can transport oxygen ions. These materials can be used to separate oxygen from air. These materials are particularly useful in the efficient production of synthesis gas (carbon monoxide+hydrogen) from hydrocarbons, e.g., methane, by partial oxidation of the hydrocarbon as illustrated in the following equation:

CH₄+1/2O₂→CO+2H₂

The synthesis gas product mixture can be converted into value added chemicals through the Fischer-Tropsch reaction. Efficient conversion of methane and other light hydrocarbons to synthesis gas makes the recovery of methane from gas and oil reserves a favorable operation. The reaction is exothermic and the energy release can be modified by addition of carbon dioxide or water (steam) which react endothermically with methane and which can modify the H₂:CO ratio in the product stream.

While a number of mixed ionic and electronic conducting ceramics have been identified (see, for example, PCT application W096/14841) significant problems still remain in the manufacture of membranes that are of practical use under the extreme operating conditions of synthesis gas production. Membranes must exhibit long term stability and high strength to resist cracking. The opposite surfaces of the membrane are exposed to highly oxidizing and highly reducing atmospheres, respectively. In addition, while ceramic materials in general have relatively low thermal expansion coefficients, many mixed conductor materials have high expansion coefficients. Mixed conductor materials exhibit both thermal expansion (associated directly with increasing temperature) and chemical expansion (associated with a change in composition as a function of temperature without a change in crystal structure). In mixed conductors used for oxygen separation and in synthesis gas reactors, the change in chemical expansion is the result of changes in oxygen concentration in the membrane material as a function of temperature and oxygen partial pressure. Large expansion coefficients can cause excessive stresses in reactor design resulting in mechanical instabilities in the membrane reactor and membrane failure through cracking or leaking.

U.S. Pat. No. 5,888,272 (Prasad et al.) and U.S. Pat. No. 5,911,860 (Chen et al.) provide a list of potential mixed ionic and electronic conductor materials in the fluorite and perovskite crystal structures of interest for oxygen separation in applications to enriched combustion. The Chen et al. patent described a certain ion transport membrane that contains a distinct constituent that enhances mechanical properties of the membrane.

The mixed ionic- and electronic-conducting mixed metal oxides of this invention have high ion (e.g., oxygen ion) flux rates, while maintaining reasonably low expansion coefficients.

### SUMMARY OF THE INVENTION

This invention relates to ceramic compositions for use in ceramic membranes in catalytic membrane reactors (CMRs). The ceramic compositions exhibit high ionic conductivity, high electronic conductivity, high chemical stability under CMR operating conditions and a low coefficient of expansion. The membranes of this invention are of particular interest for use in CMRs for the production of synthesis gas.

Mixed ionic- and electronic-conductors of this invention have the general formula:

Ln₁₋ₓSr_{y}Ca_{x-y}MO_{3-δ}

where Ln is selected from the f block lanthanides and yttrium and mixtures thereof; M is selected from the d block transition metals or mixtures thereof; 0.1≦x≦0.4; 0.01≦y ≦0.25 and δ is a number that satisfies the valences of the metals and varies to maintain charge neutrality. Preferred Ln are lanthanum (La) and mixtures of La and Y. Preferred M are Fe and mixtures of Fe with other d block transition metals.

Mixed conductors of this invention include those with compositions of stoichiometry:

Ln_{0.75}Sr_{y}Ca_{0.25-y}MO_{3-δ}

where Ln, M, y and δ are as defined above. In preferred conductors of this stoichiometry, 0.05≦y≦0.25, Ln is La and M is Fe.

Mixed conductors of this invention include, among others:

La_{0.75}Sr_{0.125}Ca_{0.125}FeO_{3-δ};

La_{0.75}Sr_{0.20}Ca_{0.05}FeO_{3-δ};

La_{0.75}Sr_{0.10}Ca_{0.15}FeO_{3-δ}; and

La_{0.75}Sr_{0.05}Ca_{0.20}FeO_{3δ}.

In preferred embodiments, a portion of the strontium in the mixed metal oxides of formula:

Ln₁₋ₓSrₓMO_{3-δ}

where x ranges from about 0.1 to about 0.4, is replaced with Ca. The resulting materials exhibit high oxygen flux and good performance with high CO/CO₂ selectivity and long term stability and high strength in membranes for synthesis gas production. The resulting calcium-containing materials exhibit lower expansion coefficients as a function of temperature than the corresponding mixed metal oxides that do not contain calcium without significant loss of ion conduction, measured as oxygen flux.

The mixed conducting metal oxide materials of this invention may be prepared as single-phase materials or as mixed-phase materials that contain relatively small amounts of distinct second ceramic phases, such as Sral₂O₄-type compounds. These second phases need not be mixed conductors, but they preferably do not have a significant detrimental effect on ionic and electronic conduction of the mixed conducting metal oxide. The second phase can enhance the mechanical properties of the materials. Second phases present in amounts less than or equal to about 20% can act as sintering aids and/or further improve the mechanical properties of the membrane. More preferred materials contain less than about 10% or less than about 5% by weight of a second phase.

Ceramic membranes of this invention can have any shape, form or dimensions suitable for use in various CMRs. In particular, membranes can be tubes of various diameters and lengths and flat plates or disks of various diameters. Ceramic membranes can be substantially composed of single or mixed-phase ceramic as a dense material with membrane thicknesses ranging from about 0.5 to about 2mm. Alternatively, gas-impermeable membranes can be composed of a porous substrate supporting a dense thin film of the single- or mixed-phase ceramic, typically having a 1 film thickness of about 1 μm to about 300 μm, more preferably having a thickness of 10 μm to about 100 μm.

Ceramic membranes prepared from ionic- and electronic-conducting metal oxides of the above formula have relatively low expansion coefficients as a function of temperature. Preferred membranes have expansion coefficients of about 10×10⁻⁶/° C. or less. Preferred membranes exhibit total synthesis gas production rates of about 10 ml/min cm² or more, for a membrane of a given thickness.

Ceramic membranes prepared using ionic- and electronic-conducting metal oxides of the above formula exhibit good stability under CMR conditions, particularly under the reactor conditions for synthesis gas production. These membranes can be employed in reactors described herein under synthesis gas reactor conditions for several thousand hours or more without failure.

The invention also provides methods for making gas-impermeable membranes for use in CMRs, particularly for use in CMRs for synthesis gas production. In these methods a metal oxide exhibiting mixed ion and electron conduction is produced and used to form dense membranes by isostatic pressing or to form membranes having dense thin films on porous substrates.

### BRIEF DESCRIPTION OF THE DRAWINGS

FIG. 1 is an X-ray diffractometer tracing of La_{0.75}Sr_{0.125}Cao0.125FeO_{3-δ}. Peaks marked by “X” may result from distortion of the perovskite cell.

FIG. 2 is a graph of total syngas production rates in ml/min-cm² as a function of Sr content using membranes of Lao₇₅Sr_{y}Ca_{0.25-y}FeO₃-, where y is 0.125 or 0.25.

### DETAILED DESCRIPTION OF THE INVENTION

Mixed ionic- and electronic-conducting (MIEC) membranes behave as short-circuited electrochemical cells, with appropriate catalysts applied for promoting each half reaction on their respective oxidizing and reducing surfaces. Ionic transport of 02 proceeds from reducing to oxidizing membrane surfaces with electrons mediating from oxidizing to reducing surfaces via the ceramic membrane.

A catalytic membrane reactor (CMR) has an oxidation zone and a reduction zone separated by a gas-impermeable membrane. The membrane surface in contact with the reduction zone is the reduction surface which optionally has a reduction catalyst layer. The membrane surface in contact with the oxidation zone is the oxidation surface which optionally has an oxidation catalyst layer. The reactor is provided with passageways for entrance and exit of gases from the reduction and oxidation zones. Multiple CMRs can be linked in series or in parallel (with respect to gas flows) for improved efficiency or speed of reaction.

A variety of CMRs are known in the art and can be employed in combination with the improved membranes of this invention. The improved mechanical properties of the membrane materials herein are particularly useful in systems employing tubular membranes and any other membrane structures or configurations that are subject to increased stresses during operation. U.S patents 5,817,597; 5,712,220; 5,723,074; 5,580,497 and 5,888,272 provide examples of CMRs and CMR processes in which the catalytic membranes of this invention can be used.

PCT application W098123051, filed Oct. 29 1998, which is incorporated in its entirety herein by reference to the extent not inconsistent herewith, describes catalytic membrane reactors having a three-dimensional catalyst within the reactor. Catalytic membranes of this invention can be employed in the reactor systems described therein. The performance of exemplary membrane materials of this invention have been assessed in this type of reactor.

In a CMR, an oxygen-containing gas or gas mixture, such as air, is passed in contact with the membrane in the reduction zone, and the reactant gas or gas mixture, i.e., the oxygen-consuming gas, such as a reactant gas containing methane or other hydrocarbons, is passed in contact with the membrane in the oxidation zone. As the oxygen-containing gas or gas mixture contacts the membrane, oxygen is reduced to oxygen anions which are transported through the membrane (as ions) to the membrane oxidation surface, facing the oxidation zone. In the oxidation zone, the oxygen anions react with the oxygen-consuming gas or gas mixture, oxidizing the oxygen-consuming gas and releasing electrons. The electrons return to the membrane reduction surface facing the reduction zone via transport through the membrane.

Membranes of CMRs are employed to form a gas-impermeable, yet ion and electron conducting, barrier between the oxidation and reduction zones of the reactor. Membranes are typically mounted between the reactor zones employing a gas-impermeable sealant. A variety of methods and sealing materials are known in the art for construction of CMRs. U.S. provisional application 60/129,683, filed Apr. 16, 1999, provides improved sealant materials for use in CMRs having mixed metal oxide membranes. This provisional application is incorporated in its entirety by reference herein to the extent not inconsistent herewith.

The term “oxygen-containing gas” is used broadly herein to include gases and mixtures of gases in which at least one of the component gases is oxygen or an oxide. The oxygen or oxide component of the gas is capable of being reduced at the reduction surface of the membrane of this invention. The term includes carbon, nitrogen, and sulfur oxides (COₓ, NOₓ. and SOₓ) among others, and gas mixtures in which an oxide is a component, e.g. NOₓ, in an inert gas or in another gas not reactive with the membrane. The term also includes mixtures of oxygen in other gases, e.g., O₂ in air. In the reactors of this invention, the oxygen-containing gas is passed in contact with the reduction surface of the membrane and the oxygen-containing component of the gas is at least partially reduced at the reduction surface, e.g., NOₓ to N₂. The gas passing out of the reduction zone of the reactor may contain residual oxygen or oxygen-containing component. The preferred oxygen-containing gas for use in synthesis gas production is air.

The term “reactant gas” is used broadly herein to refer to gases or mixtures of gases containing at least one component that is capable of being oxidized at the oxidation surface of a reactor of this invention. Reactant gas components include, but are not limited to methane, natural gas (whose major component is methane), gaseous hydrocarbons including light hydrocarbons (as this term is defined in the chemical arts), partially oxidized hydrocarbons such as methanol alcohols (ethanol, etc.) and organic environmental pollutants. Reactant gases include mixtures of reactant gas components, mixtures of such components with inert gases, or mixtures of such components with oxygen-containing species, such as CO, CO₂ or H₂O. The term “oxygen-consuming gas” may also be used herein to describe a reactant gas that reacts with oxygen anions generated at the oxidizing surface of the membrane. Reactant gas also includes gases with suspended or entrained particles, such as carbon particles slurried in water vapor.

The term “oxygen-depleted gas” refers to a gas or gas mixture from which oxygen has been separated by passage through a reactor of this invention (i.e., the residual of the oxygen-containing gas). The term “sweep gas” refers to a gas or gas mixture that is introduced into the oxidation zone of a reactor used for oxygen separation to carry the separated oxygen. The sweep gas may be an inert gas, air or other non-reactive gas that substantially does not contain components that will be oxidized in the oxidation zone of the reactor. The sweep gas can be applied to mixtures containing some oxygen, such as air, the oxygen content of which will be increased by passage through the oxidation zone of the reactor.

The term “partial vacuum” applies to the application of a partial vacuum, i.e., less than ambient pressure, to the oxidation zone of a reactor and may refer to high or low vacuum depending upon the construction of the reactor. Application of a partial vacuum to the oxidation zone of a reactor used for oxygen separation can be employed to collect gases for ultimate concentration of the separated oxygen. Gases in the oxidation or reduction zones of the CMR can be at ambient pressure or at pressures higher or lower than ambient.

The terms “reactant gas,” “oxygen-depleted gas,” “oxygen-consuming gas,” and “oxygen-containing gas” and any other gas mixture discussed herein include materials which are not gases at temperatures below the temperature ranges of the pertinent process of the present invention or at pressures of the CMR, and may include materials which are liquid or solid at room temperature. An example of an oxygen-containing gas which is liquid at room temperature is steam.

The term “gas-impermeable” as applied to membrane of this invention means that the membrane is substantially impervious to the passage of oxygen-containing or reactant gases in the reactor. Minor amounts of transport of gases across the membrane may occur without detriment to the efficiency of the reactor. It may be that membranes of this invention will allow passage of low molecular weight gases such as H₂. The membranes of this invention conduct oxygen anions and in this sense are permeable to oxygen.

Examples of processes which may be conducted in CMRs using MIEC membranes include the combustion of hydrogen to produce water, the partial oxidation of methane, natural gas or other light hydrocarbons to produce unsaturated compounds or synthesis gas, the partial oxidation of ethane, extraction of oxygen from oxygen-containing gases, e.g., extraction of oxygen from: NOₓ, wherein x has a value from 0.5 to 2; SO_{y}, wherein y has a value from 2 to 3, steam, or CO₂; ammoxidation of methane to hydrogen cyanide, and oxidation of H₂S to produce H₂O and S.

The partial oxidation of methane and other hydrocarbons to produce synthesis gas (syngas) is a spontaneous process to produce either a high value fuel or a feedstream for high value chemicals. This process can be carried out in the presence of CO₂ and steam. When these ceramic materials are used for the partial oxidation of methane to produce syngas, the reaction can be written:

CH₄+1/20₂→CO+2H₂

The product mixture can be converted to value added chemicals through the Fisher-Tropsch reaction. This would make the recovery of methane from gas and oil reserves a favorable operation. The reaction is exothermic, and the energy release can be modified by addition of CO₂, carbon dioxide or H₂O, steam, which react endothermically with CH₄, and which can modify the H₂:CO ratio in the product stream. At the heart of the process is the ceramic membrane reactor which separates pure oxygen from the air. Mixed conductors are suited for this type of use

Coal gasification also produces syngas, but by the combination of steam reforming and partial oxidation of carbon. In this case, the reactant gas can be a slurry of carbon particles in steam. The overall reaction for this process can be written:

2C+1/20₂+H₂O →2CO+H₂

A further reaction that can be conducted with CMR is the oxydehydration reaction of ethane, according to the reaction:

C₂H₆+1/20₂→C₂H₄+H₂O.

Coupling reactions can also be facilitated by these membranes. One example is the coupling of methane to form ethane or ethylene, or of methane and ethane to form propane, and higher alkanes and alkenes. The coupling of toluene (C₆H₅CH₃) to form ts stilbene (C₆H₅CH=CHC₆H₅), as an intermediate in the formation of benzoic acid, can also be carried out using these membranes.

Partial oxidation and coupling reactions of CMRs can employ unsaturated and saturated linear, branched, and cyclic hydrocarbons, partially oxidized hydrocarbons, as well as aromatic hydrocarbons as reactants. Specific examples include methane, ethane, ethylene, propane, etc., cyclopropane, cyclobutane, cyclopentane, cyclopentene, etc., isobutane, isobutene, methylpentane, etc., and benzene, ethylbenzene, napthalene, methanol, ethanol, etc. Products of reactions with these various hydrocarbon species will generally depend upon the types of oxidation and or reduction catalysts on the membrane surfaces.

All of the listed examples make use of pure oxygen as a reactant. CMRs may also be used for the separation and production of high purity oxygen. Because these reactions make use of pure oxygen separated from the air by the mixed conducting membrane, there is no nitrogen present, and hence no NOₓ compounds are generated. The formation of the products acts a driving force for the permeation of oxygen through the ceramic membrane, as the reaction of oxygen maintains a very low partial pressure of oxygen on the product side. Particularly in the case of coupling reactions, selection of catalysts for the oxidation and/or the reduction surface of the membranes is important to improve production with optimal selectivity.

Another type of process suitable for CMRs, is the reaction of an oxygen-containing gas which is capable of losing oxygen, for example, NO, NO₂, SO₂, SO₃, CO, CO₂, etc. The oxidation zone of the reactor is exposed to a partial vacuum, an inert gas, or a gas that will react with oxygen (e.g., various hydrocarbons). Effective ranges of partial vacuum range from approximately 100 Torr to 10⁻⁶ Torr. An example is where the reactant gas is methane, natural gas, or hydrogen and the oxygen-containing gas is a flue or exhaust gas containing NOₓ, and or SO_{y}, wherein x is 0.5 to 2 and y is 2 to 3. As the flue gas contacts the membrane, any oxygen present or the oxygen in NOₓ and/or SO_{y} is reduced to oxygen anions which are transported through the membrane to the oxidation zone where the oxygen anions react with the oxygen-consuming gas to produce carbon dioxide and water, synthesis gas or olefins, depending on the reaction conditions. Nitrogen gas and elemental sulfur are produced from NOₓ and SO_{y} respectively, in the reduction zone.

In another type of CMR reaction, the oxygen-containing gas is a gas-containing steam (i.e., H₂O gas). As H₂O contacts the membrane, the oxygen of H₂O is reduced to oxygen anions which are transported through the membrane to the oxidation zone where the oxygen anions react with methane or natural gas, for example. The H₂O is reduced to hydrogen gas (H₂) in the reduction zone. The hydrogen gas may be recovered and used, for example, to hydrogenate unsaturated hydrocarbons, provide fuel for an electrical current generating fuel cell, to provide fuel for heating the catalytic membrane reactor of this invention or to provide reactant gas for the process for extracting oxygen from an oxygen-containing gas in accordance with the present invention.

Materials which are co-present in any reactor feed gases may participate in catalytic membrane reduction or oxidation taking place at the membrane of the present invention. When, for example, methane is present with ammonia in the oxidation zone and an oxygen-containing gas is present in the reduction zone, hydrogen cyanide and water can be produced in the oxidation zone. Reactors of the present invention can also be applied to the oxidative reforming of CO₂/CH₄ mixtures to synthesis gas. Other combinations of materials reactive with each other in CMRs to produce a wide range of products are possible and are contemplated as being within the scope of the invention.

It has been found that certain catalysts may be used to significantly enhance the efficiency of the reaction being mediated by the membrane. Catalysts to be used are specific to each reaction. For example, in the partial oxidation of methane, natural gas, or light hydrocarbons to synthesis gas, the catalyst must be able to dissociatively adsorb the hydrocarbon species, followed by oxygen atom transfer to the dissociatively adsorbed residue. The first requirement is met with catalysts possessing considerable hydrogen affinity (e.g., surface hydride forming ability or surface basicity). Oxygen atom transfer to the residue implies that the catalyst possesses only modest metal-oxygen binding energy and is reversibly reducible. Catalysts possessing these features include the platinum group metals Ni, Pd, Pt, Rh, Ru, Ir, and Os, as well as the first row transition metals Fe, Mn, and Co. Incorporation of these metals or their combinations onto the oxidation surface of oxygen anion conducting membranes provides a strategy for direct partial oxidation of hydrocarbons. Moderation of catalyst activity to avoid coke formation is achieved by the incorporation of metal clusters into ceramics such as CeO₂, Bi₂O₃, ZrO₂, CaB₁₋ₓ,B′ₓO_{3-δ}, SrB₁₋ₓB′ₓO_{3-δ} or BaB₁₋ₓB′ₓO_{3-δ} where B=4+-lanthanide ion such as Ce, Tb, or Pr; B′=3+-lanthanide ion such as Gd or Nd; 0<x<0.2; and δ is a number that makes the compound charge neutral). Additionally, incorporation of transition metal ions into the B-site of a perovskite, with a basic A-site, will give an active catalyst since the bonding of the metal ion to oxygen will be correspondingly weakened and the oxygen atom transfer activity of the metal ion enhanced. Perovskites possessing the general formula A₁₋ₓAₓ′B_{1-y}B_{y′O}_{3-δ} (where A=lanthanide metal ion or Y; A′=alkali or alkaline earth cation; 0<x<0.8; and δ is a number that makes the compound charge neutral; B=transition metal ion such as Fe, Ni, or Co; B′=Ce or Cu, Ag, Au or Pt, Pd, or Ni and 0<y<0.3).

For the reductive decomposition of NOₓ and SOₓ, as well as for oxygen concentration, perovskites are again favored catalysts. In NOₓ decomposition, the catalyst must preferentially adsorb NOₓ over O₂ and permit the facile release of adsorbed O atoms. The first requirement is met by the use of the first row transition is metal ions including Fe, Co, Ni, and Cu, as well as by group Vil metals such as Ru, Pt, or Pd in the B-site. The second requirement is met by the employment of basic or low melting metals in the A-site (Pb, Bi, or Sb, lanthanides or Group IA and IIA dopants) as well as by the use of Ru or Group IB metals (Ag or Au) as a B-site dopant. These conditions are expected to produce generally weak M—O bonds, permitting the required surface and bulk mobility of oxygen ions. In addition, catalysts such as transition metals (Cu, Ag, Au, Pd, Pt, Rh, Ir, Os) supported on metal oxides, (e.g., Fe₂O₃, Co₂O₃, Fe₃O₄, NiO, Ni₂O₃, MnO, MnO₂) and prepared by various methods such as coprecipitation, impregnation, etc., are expected to be active.

SO_{X} decomposition may be promoted in a similar manner to NOₓ decomposition, but the issue of sulfur tolerance arises. In that case, materials based on the Group VIB metals (Cr, Mo, and W) such as WS₂ or WC or on the Group VII metals (Fe, Co, Ni, and Cu) such as the thioperovskites ABS₃ (where A is a lanthanide and B is a Group VII metal), thiospinels AB₂S₄ (where A is a 2⁺ Group VII ion and B is a 3⁺ Group VII ion) or Chevrel phases A₂MO₆S₈ (where A is Fe, Co, Ni, Cu, Zn) are applicable. Similar requirements for oxygen reduction as for NOₓ reduction point to the use of similar perovskite catalysts.

H₂S decomposition is similar to that of SOₓ decomposition. The preferred catalysts for this process are thiospinels AB₂S₄ (where A is a 2⁺ Group VII ion and B is a 3⁺ Group VII ion) or WS₂.

Previous work examining oxygen desorption using Temperature Programmed Desorption (TPD) from perovskite oxides has shown that two types of oxygen can become desorbed (Y. Teraoka, H.-M. Zhang and N. Yamazoe, Chem. Lett. 1367 (1955)). Here oxygen desorbed at lower temperatures, termed a oxygen, corresponds to adsorbed surface oxygen, and that desorbed at higher temperatures, designated β oxygen, is desorbed from lattice sites within the perovskite. TPD studies on oxygen desorption from perovskite oxides have been studied as a function of the nature and concentration of dopant atoms introduced into both the A- and B- sites. A brief discussion of some of these results and their relevance to selection of perovskite sites for oxygen evolution at intermediate temperatures is presented below.

TPD studies of oxygen evolution from perovskite oxides has shown the amount of α-oxygen desorbed from Lni-AMO₃ (Ln is a lanthanide, A is an alkaline earth metal, and M is Co, Fe, Ni, or Cr) was a function of x and hence the vacancy concentration and was little affected by the nature of the B-site. These results suggested that α-oxygen occupied normally empty oxygen vacancy sites. The onset temperature where α-oxygen evolved was found to increase upon going from Ba to Sr to Ca in the A lattice site. Calculation of the average metal oxygen bond energy for the series La₁₋ₓAₓCoO₃ (A is Ba, Sr and Ca) using the equation:

ABE=1/12•m(ΔH_{A}_{ₘ}_{O}_{ₙ}−mΔHₐ−1/nD_{(O}_{₂}₎)+⅙•m(ΔH_{B}_{ₘ}_{O}_{ₙ}−m→H_{B})

where ΔH_{A}_{ₘ} Oₙ and ΔH_{A}_{ₘ} Oₙ are the heats of formation of the AₘOₙ and BₘOₙ oxides, respectively, ΔH_{A} and ΔH_{B} the heats of sublimation of the metals A and B, respectively, and D_{(O}_{₂}) is the oxygen dissociation energy, shows that the average metal-oxygen bond energy decreases in the order La₁₋ₓCaₓCoO₃, La₁₋ₓSrₓCoO₃, La₁₋ₓBaₓCoO₃. Thus, the α-oxygen desorption temperature is dependent on the average metal-oxygen bond strength at the perovskite surface. α-oxygen desorption is due to removal of oxygen from normal lattice sites accompanied by reduction of the formal B site oxidation cation by one. More recent work has shown that partial substitution of the B-site cation in La_{0.6}SrO_{0.04}CO_{0.8}M_{0.2}O₃ with Cr, Mn, Fe, Ni, Ni and Cu affects both the onset temperature for and the amount of α-oxygen evolved. The amount of α-oxygen evolved decreased in the order Cu>Fe>Ni>Mn>Cr. (Y. Teraoka, T. Nobunaya, N. Yamazoe, Chem. Lett. 503 (1988).)

Good oxygen evolution catalyst sites can occur when using perovskites possessing the general composition BaCo₁₋ₓM_{X}O_{3-δ}, where M is Fe, Cu or Ag and x is a number from 0 to 1. For these compositions the vacancy concentration has been maximized by total replacement of the Ln³⁺ cation by the alkaline earth cation Ba²⁺. Previous work (M. Crespin and K. W. Hall, J.Cat. 69, 359 (1981)) suggests that water decomposition at perovskite surfaces proceeds via reaction with oxygen vacancies. Additionally, selection of Ba over Sr or Ca leads to lower average metal-oxygen bond strengths and B site doping with Fe, Cu or Ag has been previously shown to enhance oxygen desorption.

As a consequence, perovskite electrocatalysts of formula BaCo₁₋ₓM_{X}O_{3-δ}, where M is Fe, Cu or Ag (0.05≦x≦0.2) are of significant interest for catalytic reactors of this invention. The predominance of Co in the B lattice site is compatible with both the oxygen dissociative adsorption and oxygen evolution step. Introduction of Fe, Cu and Ag into this lattice site will contribute to low overpotentials associated with the oxygen evolution reaction.

Metal oxide supported Ni can be employed on a membrane of this invention as a catalyst for CO₂/CH₄ oxidative reforming to synthesis gas. The Ni:support ratio in these catalysts can vary from about 5:100 (5%) to about 100% Ni. Preferred Ni:support ratios are from about 1:10 (10% Ni) to 4:10 (40% Ni). Supports employed included inert supports (such as y-Al₂O₃) and ionic- and electronic-conductors. Supports having Cr and Mn ions are expected to promote CO₂ absorption facilitating the reforming reaction. A preferred catalyst is Ni supported LSM. In addition, supports based on substitution of Cr and Mn into the metal oxide structure La_{0.4}Sr_{1.6}GaFeO_{5.2}.₂ are useful as catalyst supports in this system.

Reduction catalysts for synthesis gas production include mixed conductor materials (e.g., lanthanum strontium cobaltate) and supported platinum group metal, e.g., Ni, Pd, Pt, Rh, Ru, Ir, and Os, catalysts. The metal:support ratio in these catalysts can vary from about 5:100 (5 wt. %) to about 100 wt. %. Preferred catalysts have from about 5 wt. % to about 40 wt. % metal on the support. Supports employed included inert supports (such as y-Al₂O₃) and ionic- and electronic-conductors, such as LSC (lanthanum strontium cobaltate). Preferred reduction catalysts for synthesis gas production include LSC or Pt-supported on LSC.

Catalysts for hydrocarbon coupling include, but are not limited to, perovskite electrocatalysts. These catalysts generally have a transition metal on the B site of the ABO₃ perovskite structures. The A site is occupied by two different f-block elements or IA elements. Examples are Sm_{0.5}Ce_{0.5}CuO₃, Tb_{0.8}Sm_{0.2}CuO₃, Gd_{0.9}Th_{0.1},CuO₃, Gd_{0.9}Na_{0.1}MnO₃, and Th_{0.8}Yb_{0.2}NiO₃ (Kuchynka, D.J. et al. (1991) J. Electrochem. Soc. 138:1284).

Membranes useful in the CMRs of this invention can be dense, gas-impermeable sintered materials in any desired shape, including membrane disks, flat plates, open tubes, closed-one-end tubes, etc., which can be adapted to form a gas-tight seal between the two reactor zones or chambers of CMRs. Membranes can be composed substantially of the mixed-phase ceramic material described herein or can be composed of porous substrate with a gas impermeable thin film of the mixed-phase ceramic material described herein.

Membranes can be formed by isostatic pressing of mixed metal oxide materials of this invention into dense substantially gas-impermeable membranes. Alternatively, substantially gas-impermeable membranes can be formed by forming dense thin films of ionically and electronically conducting mixed metal oxide on porous substrate materials. Again these two component membranes (porous substrate and dense thin film) can have any desired shape including disks, tubes or closed-one-ended tubes. Porous substrates (which allow passage of gas through the substrate) can include various metal oxide materials including metal-oxide stabilized zirconia, titania, alumina, magnesia, or silica, mixed metal oxide materials exhibiting ion and/or electronic conduction or metal alloys, particularly those that minimally react with oxygen. The substrate material should be inert to oxygen or facilitate the desired transport of oxygen. More preferred substrates are those that have a thermal expansion coefficient (over the operational temperatures of the reactor) that is matched to that of the mixed metal oxide ion/electron conducting material.

Thin films (about 1-300 μm thick) of the mixed metal oxides of this invention are formed on the porous substrate by a variety of techniques, including tape casting, dip coating or spin coating. A presently preferred two component membrane is prepared by forming dense thin films of the mixed conducting metal oxides of this invention on a porous substrate formed from the same mixed conducting metal oxide material.

More specifically gas-impermeable membranes of this invention comprising an ionic- and electronic-conducting material can be prepared by admixing precursors of the metals Sr, Ca, Ln and M, where Ln and M are as defined above, in relative molar amounts according to the stoichiometry of the mixed metal oxide:

Ln₁₋ₓSr_{y}Ca_{x-y}MO_{3-δ}

The precursors are optionally combined in an appropriate organic liquid, e.g., an organic alcohol, such as propanol or isopropanol, to facilitate mixing. The mixed precursors are milling to obtain a homogeneous powder and calcined at temperatures ranging from about 1100-1250° C. until the reaction is complete. The powder is preferably calcined twice with an intermediate step of grinding and sieving the calcined material. The reaction is complete when no change in the X-ray diffraction pattern of the calcined material is observed.

Metal precursor materials include metal oxides, metal carbonates, metal acetates, metal halides and/ or metal nitrates of the metals of the formula above (Ln, Sr, Ca and M).

To form dense membranes, calcined powder is isostatically pressed to form a desired membrane shape (e.g., disk, closed-one-end tube, etc.). The powder is optionally mixed with an appropriate binder, such as polyvinylbutyral binder, prior to pressing. The pressed shaped membrane is then sintered in air at temperatures ranging from about 1100-1250° C. to form a dense membrane which is gas-impermeable.

Alternatively, the calcined powders can be used as discussed above to form dense thin films on a porous substrate.

Preferred gas-impermeable membranes of this invention are those that having an expansion coefficient less than about 10×10⁻⁶/° C. and exhibit a total syngas production rate of at least about 10 ml/min-cm², for a membrane of a given thickness.

In operation, ceramic membranes in CMRs are subjected to several stresses. Reactor design can minimize these stresses, but cannot totally eliminate the problem. In the use of tubular ceramic membranes, for example, which are supported on alumina tubes, gas tight seals must be formed which accommodate the thermal expansion mismatch of the dissimilar reactor components. Chemical expansion also creates stresses which must be minimized. Again, using tubular ceramic membranes as an example, gas flows for the conversion of methane to synthesis gas are designed to flow air through the inner length of the tube, with methane flowing over the outside surface of the tube. Reversing the gas flows can cause the membrane tubes to burst. This effect is related to the chemical expansion of the materials under oxidizing and reducing atmospheres. The materials of this invention possess low expansion coefficients to help alleviate this problem.

Another stress that membranes are subjected to during operation is stress due to chemical expansion. Ceramic metal oxides heated in air are generally chemically reduced. The loss of oxygen from the lattice causes an expansion in the unit cell. The loss of oxygen, and hence the chemical expansion, is modified by heating under either more oxidizing or reducing gases. When opposite sides of a membrane are heated under different atmospheres (different gases which may be at different pressures and may have different oxygen partial pressures), a gradient of oxygen occupancy can exist through the membrane thickness. Hence, the stresses due to chemical expansion vary through the thickness of the membrane. Again, the materials of this invention are resistant to the effect of chemical expansion.

The membrane materials of this invention may be single-phase or mixed-phase containing may small amounts of distinct second phase. In a crystalline single-phase material, the elements combine in a well-ordered array. The presence of a single-phase can be assessed by XRD or similar known techniques of phase identification (scanning electron microscopy (SEM) or transmission electron microscopy (TEM)).

A mixed-phase material contains one or more distinct crystalline phases. In the mixed phase materials of this invention, the predominate phase is a material that exhibits both ionic and electronic conductivity (MIEC). The second phase or phases present enhance the mechanical strength of the mixed phase material. Exemplary second phases are mixed metal oxides distinguishable in structure from the predominant MIEC phase. The presence and amounts of second phases in the mixed phase materials of this invention can be assessed by X-ray diffraction or by SEM or TEM techniques as is known in the art. Crystalline second phases can be detected by X-ray diffraction if they are present at levels of about 4 wt. % or more. The amount of second phase detectable by X-ray diffraction depends upon the specific second phase or phases present. SEM and particularly TEM methods can typically be employed to quantify lower amounts of second phases.

In preferred ceramic compositions, the mixed ionic- and electronic-conducting phase of the ceramic materials of this invention represents about 80 wt. % or more of the composition. In more preferred compositions, the mixed conducting phase represents about 90 wt. % or more of the composition. Lower levels (up to about 5 wt. %) of second phases can arise as impurities during the preparation of mixed conducting materials, because of impurities in starting material resulting in inaccuracies in measurement of metal stoichiometries prior to reaction. Second phases can also be selectively added to mixed conducting phases up to about 20 wt. % by mixing components in off-stoichiometric amounts, i.e., by adding additional amounts of one or more metal precursors.

Second phases can be added to the mixed conductor materials by any method. One method is to add the desired second phase or phases to a substantially single-phase mixed conductor material in powder form, and mix thoroughly to distribute the second phase homogeneously in the mixture prior to pressing and sintering membranes. Another method is to form the second phase or phases simultaneously with the formation of the desired membrane material by mixing metal precursors in an tn off-stoichiometric ratio.

Mixed-phase materials of this invention can be prepared by combining starting materials (metal precursors) in off-stoichiometric ratios. The term “stoichiometric” refers to the relative molar amounts of starting metal compounds (metal precursors, e.g., metal oxides or carbonates) combined to obtain a mixed metal oxide of a given formula. Stoichiometric mixing provides the component metals in the a correct relative molar amounts according to a given mixed metal oxide formula.

The term “off-stoichiometric” refers to the relative amounts of starting materials combined to be somewhat off (i.e., higher or lower) of those required for the formula of the desired mixed conducting phase. In an “off-stoichiometric” composition, one or more of the starting components are present in a higher or lower amount than required to obtain the desired stoichiometry of the mixed conducting phase.

### EXAMPLES

### Example 1

### General Preparation of Membranes from Single-Phase and Mixed-Phase Mixed Metal Oxides

Starting materials for preparation of single- and mixed-metal oxides are obtained from commercial sources and typically are employed without further purification. For specific examples below, La₂O₃, SrCO₃, and Al₂O₃ are obtained from Alfa/Aesar at purities indicated below. Fe₂O₃ and CaCO₃ were obtained from Aldrich. A Loss on Ignition test (LOI) is performed on the above reagents to determine the amount of volatile compounds, (i.e., water, or CO₂) which are absorbed on the powders. For the SrCO₃ used LOIs range from about 0.5% to about 2.0% by weight. La₂O₃ is found to have LOIs ranging from about 0.9 to about 9.8% by weight. The other materials are found to have negligible LOIs. The LOI of a material received from a given supplier will generally vary with batch or lot and must be redetermined when a new batch or lot is employed. The LOI of material received in an individual shipment typically remained constant throughout the shelf life (several months) of that container in the laboratory. Exposure of starting materials to humid conditions may affect LOI.

The mixed metal oxide ceramic materials of this invention are, in general, prepared from powders using standard solid state synthesis techniques. All compounds are prepared from mixtures of the appropriate metal oxide(s) and metal carbonate(s) in amounts as indicated below. Powders are placed in a small polyethylene container with an equal amount, by volume, of isopropyl alcohol. Several cylindrical yttria-stabilized zirconia (YSZ) grinding media are also added to the container. The resulting slurry was mixed thoroughly on a ball mill for several hours. The alcohol is then allowed to evaporate yielding a homogeneous mixture of the starting materials. This homogeneous mixture is calcined to obtain the desired predominant MIEC phase. Powders are placed in alumina crucibles and fired at temperatures of 1100° C. to 1450° C. for 12 h in atmosphere. Upon cooling, the powders are sieved to 45 mesh size . Calcining is repeated if necessary (typically twice) until a consistent X-ray diffraction pattern indicates that reaction has gone to completion. XRD is performed using a Philips PWl1830 X-ray generator with model 1050 goniometer for powder samples with a PW3710 control unit.

Before pressing and sintering, the particle size of the powders is reduced by attrition. A Union Process Model 01 attritor with a YSZ tank and YSZ agitator arms is used for this process. In a typical attrition, about 1.5 lbs of 5 mm, spherical YSZ grinding media are placed in the tank. Isopropyl alcohol (about 120 mL) is then added to the tank followed by about 100 g of the powder sieved to −45 mesh. The powder's particle size is reduced by attrition for 4 h, after which the alcohol is allowed to evaporate. XRD on the powder indicates that the attrition procedure does not cause decomposition. No decomposition is observed for any materials. The XRD patterns show considerable peak broadening, indicative of small particles. The particle size at this stage is believed to be submicron to several micron (e.g., 0.7-2 micron).

Membrane materials can be shaped into disks, plates, tubes, closed-one-end tubes or other useful shapes by isostatic pressing using appropriately shaped molds . For example, a commercial isostatic press (Fluition CP2-10-60) can be employed to form closed-one-end tube membranes. This press is capable of operation to 54,000 psi to form tubes of ˜4 cm outer diameter and 10 cm in length. Powder is prepared and reduced in particle size as discussed above. A PVB (polyvinyl butyral) binder is added to the powder. A rubber mold is fabricated in the desired outer shape of the tube. A small amount of powder sufficient to form the top end of the closed-one-end tube is introduced into the mold. A mandrel having the shape of the inner surface of the tube is then inserted into the mold. A plug funnel is inserted into the top of the mold to allow powder to be added evenly around the mandrel. In particular, the funnel employed is designed so that it fits over the end of the mandrel and centers the mandrel in the mold. Powder is then poured into the mold via the funnel with vibration to ensure even packing. The mold is inserted into the press. Pressure of 15,000 psi to about 30,000 psi is applied to the mold for about 2 min. After pressurization, the mold is removed and the green tube is removed from the mold. Very high green densities up to 80%, as measured by the Archimedes method, can be obtained.

Green closed-one-end tubes are sintered by placing the tubes horizontally in a crucible with zirconia powder or setter of similar composition as the membrane. XRD of the tube surface after sintering indicated that no reaction had occurred between the setter and the tube. Straight closed-end tubes of sintered density typically between about 90% to 95% can be prepared using this method. Tubes with wall thicknesses ranging from about 0.5 mm to about 1.5 mm can be made by this method.

Membrane disks were formed by mixing the powder with a binder, e.g., a standard ceramic binder, such as Ceracer C640 (Shamrock), which is a polyethylene wax, with a mortar and pestle until a homogeneous mixture was obtained. Another suitable ceramic binder is methylcellulose. The binder/powder mixture (about 1 g, was placed in a 12.5 mm diameter die. The mixture was then pressed into disks at 15,000 psi for several minutes. These “green” disks were then placed into an Al₂O₃ crucible for sintering. Disks were packed with powder of the same material to ensure that the disks did not react with the crucible or sinter together. Disks were sintered in the crucible in atmosphere for 4 h at the appropriate sintering temperature for a given material from about 1300° C. to about 1450° C. to obtain sintered disks preferably of ≧90% theoretical density. Sintering temperature for a given material was determined empirically as is known in the art. Typical ramp rates during sintering were 3° C./min for both heating and cooling cycles.

### Example 2

### Preparation of La_{0.75}Sr_{0.25}FeO_{3-δ}

The following components were mixed in isopropanol in the given amounts:

53.61 g La₂O₃ (99.9% purity by weight on a rare earth basis)

16.19 g SrCO₃ (99% purity by weight with<1 % by weight Ba)

35.03 g Fe₂O₃ (99%+purity by weight).

The amounts of metal precursors mixed were not adjusted for LOI . There is about a 2% combined deficiency in Sr and La from the stoichiometry of the formula. The product is expected to contain small, perhaps trace, amounts of second phases (e.g., strontium iron oxide, lanthanum iron oxide). The mixture was ball milled for 18-24 hr, the milled powder was dried and calcined in an alumina crucible (in air) for 6-12 hr at 1100-1250° C. The resulting calcined powder was subjected to grinding and sieving before calcining a second time at 1100-1250° C. for 6-12 hr to complete reaction. The resulting calcined material appeared to be a homogeneous single-phase powder by XRD (Philips PWl 1830). There are several weak peaks observed in the X-ray pattern which are believed to correspond to a distortion away from the ideal cubic structure of a perovskite related phase. No indication of second phases was observed in the XRD.

To prepare dense membranes, the resulting powders were mixed with polyvinylbutyral binder (2-3 wt. %, but not more than 5 wt. %), before pressing and sintering in air at 1100-1250° C. for 4-12 hrs into dense closed-one-end tubes. X-ray diffraction of sintered membranes of this material shows what appears to be single-phase material as discussed above.

### Example 3: Preparation of La_{0.75}Sr_{0.125}Ca_{0.125}FeO_{3-δ}

This material was prepared as in Example 1 by mixing the following components in isopropanol:

55.04 g La₂O₃ (99.9% purity by weight on a rare earth basis)

8.31 g SrCO₃ (99% purity by weight with<1 % by weight Ba)

5.64 g of CaCO₃ (99+% purity by weight)

35.98 g Fe₂O₃ (99+% purity by weight).

The amounts of metal precursors mixed were not adjusted for LOI . There is about a 2% combined deficiency in Sr and La from the stoichiometry of the formula. The product is expected to contain small, perhaps trace, amounts of second phases.

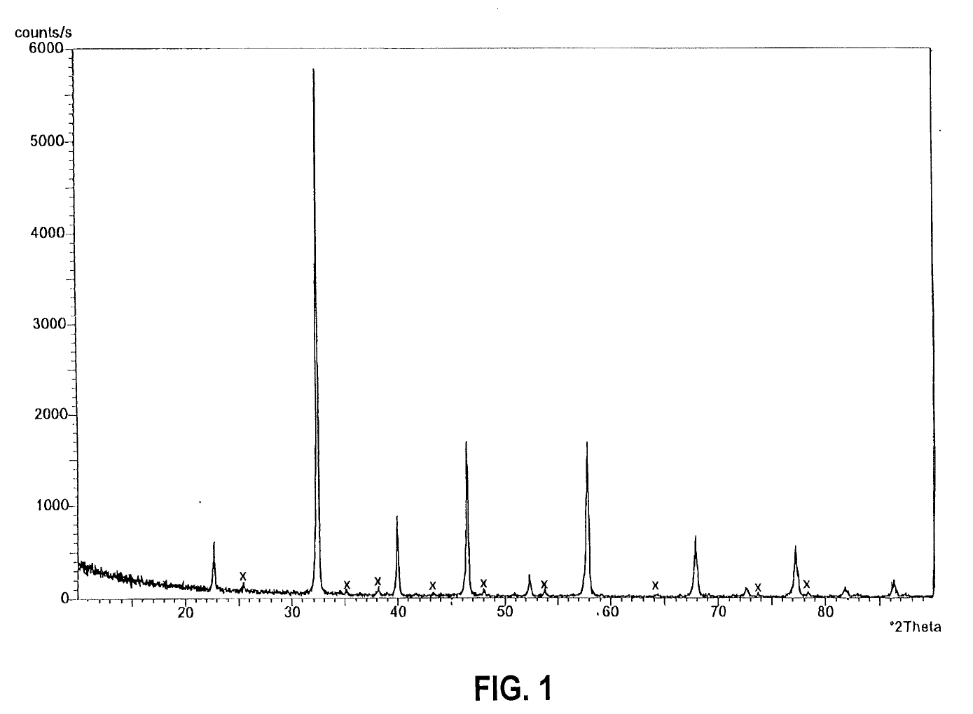

Dense membranes were prepared as in Example 1. FIG. 1 is an X-ray diffraction tracing of sintered membranes of this material. The material appears to be single-phase. There are several weak peaks (marked by “x” on the tracing) observed in the X-ray pattern which are believed to correspond to a distortion away from the ideal cubic structure of a perovskite phase. No indication of second phases was observed in the XRD.

### Example 4

### Performance Testing of Dense Membranes

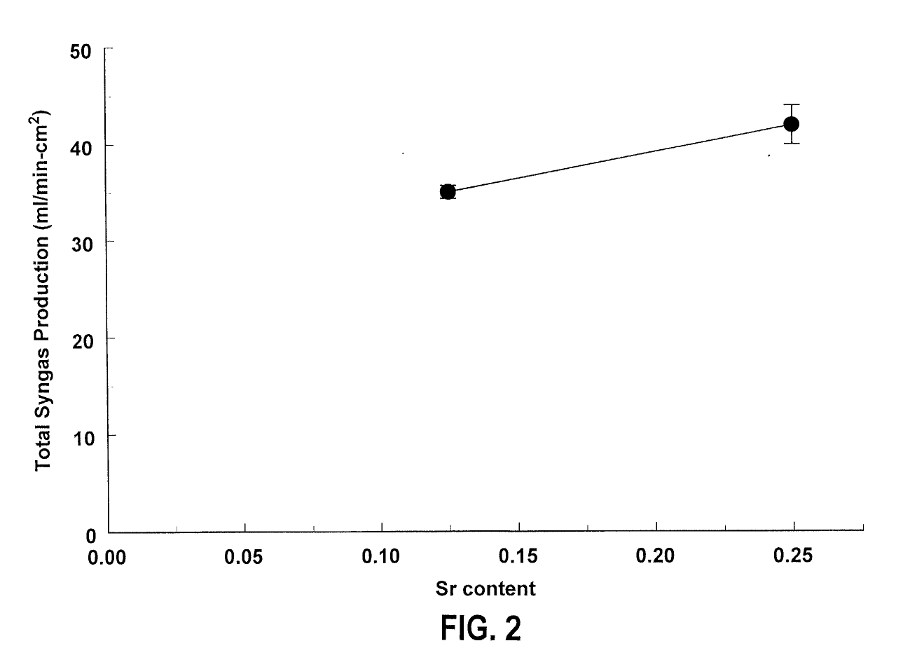

Mixed ionic- and electronic-conducting ceramic were tested for membrane performance in catalytic reactors for the partial oxidation of methane to make synthesis gas. Closed-one-end membranes with thickness ranging from 0.8 to 1.0 mm were prepared as described above. An oxidation catalyst coating of 20 wt. % Ni on LSM (lanthanum strontium manganate) was applied on the partial oxidation surface. A reduction catalyst coating of LSC (lanthanium strontium cobaltate) was applied on the partial reduction surface of the membranes. These membranes were placed in a membrane reactor (as described in PCT application W098/23051, filed Oct. 29, 1998) with a packed bed formed around the outside of the membrane tube where the packing consisted of Ni(5 wt. %) on Al₂O₃ granules. The partial reduction surface of the membrane in contact with air in the reactor was the inside surface of the one-closed-end tube. The partial oxidation surface was the outer surface of the tube in contact with a helium/methane mixture where methane content varied from 30 to 90%. The amount of methane in the mixture is adjusted to give excess methane in the product stream. The membranes were heated to about 900° C. during reaction. Reactors were run for over several hundred hours without a drop in production rates. Production rates of various product gas components are listed in Table 1 and syngas production as a function of Sr content in compounds La_{0.75}SrₓCa_{0.25-x}FeO_{3-δ} where x equals 0.125 and 0.25 as shown in FIG. 2. Total syngas production is the sum production rates of products H₂, and CO. Product gases are measured by gas chromatography. A Gow-Mac series 580 GC equipped with a 6 foot Carbosphere column (from Alitech) maintained at 80° C. was used to analyze for CO, CO₂, CH₄ and H₂.

TABLE 1
Syngas Production Rates of Catalytic Membrane Reactor Operating
at 900° C^{#}

| | | PRODUCTION | | | | CO |
|---|---|---|---|---|---|---|
| | | RATE | | | | Selec- |
| | | ml/min cm² | | | H₂: | tivity |
| Membrane Composition | | H₂ | CO | CO₂ | CO | (%) |
| La_{0.75}Sr_{0.25}FeO_{3-δ} | 384 | 27 | 15 | 0.15 | 1.9 | 99.0 |
| | | (2) | (1) | (5) | (2) | (3) |
| La_{0.75}Sr_{0.125}Ca_{0.125}FeO_{3-δ} | 192 | 22.6 | 12.0 | 0.07 | 1.90 | 99.4 |
| | | (8) | (5) | (2) | (8) | (2) |

^{#}The numbers in the parentheses indicate the standard deviation of the measurement.

Expansion coefficient=9.8

TABLE 2
Expansion Measurement of Indicated Materials

| | Expansion Coefficient |
|---|---|
| Membrane Composition | (10⁻⁶/° C.) |
| La_{0.75}Sr_{0.25}Fe_{3-δ} | 14.0 |
| La_{0.75}Sr_{01.25}Ca_{0.125}FeO_{3-δ} | 9.8 |

### Example 5

### Measurement of Expansion Characteristics of Membrane Materials

Expansion coefficients of membrane materials were measured (Table 2) using an dilatometer equipped with a quartz pushrod in a vertical position. Displacement was measured with a Linear Voltage Displacement Transducer. See, for example, Kingery et al. (1976) Introduction to Ceramics (John Wiley & Sons, New York) Chapter 12). Samples were prepared from cutting parallel ends on a membrane tube, approximately 1 inch in length. Measurements were taken as the sample was heated in air at 1° C./min from room temperature up to 1000° C. No temperature hold for equilibration were performed. The value listed in Table 2 is for the total dimension change over the entire temperature range.

Those of ordinary skill in the art will appreciate that procedures, techniques, starting materials and reagents other than those specifically exemplified herein can be used or readily adapted for use in the practice of this invention. All such procedures, techniques, starting materials and reagents that are know or discovered to be to functional equivalents of those described herein are intended to be encompassed within this invention.

All references cited herein are incorporated by reference in their entirety herein to the extent not inconsistent herewith.

We claim:

1. A gas-impermeable ceramic membrane comprising a mixed ionic- and electronic-conducting metal oxide of the formula:
Ln₁₋ₓSr_{y}Ca_{x-y}MO_{3-δ}
wherein Ln is selected from the f block lanthanides and yttrium or mixtures thereof; M is selected from the d block transition metals or mixtures thereof; 0.1≦x≦0.4; 0.01≦y≦0.25 and δ is a number that varies to maintain charge neutrality.

2. The ceramic membrane of claim 1 wherein Ln is La or a mixture of La and Y.

3. The ceramic membrane of claim 1 wherein M is Fe.

4. The ceramic membrane of claim 1 wherein x does not equal y.

5. The ceramic membrane of claim 1 wherein x is about 0.25.

6. The ceramic membrane of claim 1 that is in the form of a gas-impermeable disk, plate or tube.

7. The ceramic membrane of claim 1 wherein the mixed ionic- and electronic-conducting metal oxide forms a gas-impermeable membrane.

8. The ceramic membrane of claim 1 wherein the mixed ionic- and electronic-conducting metal oxide is in the form of a dense thin film on a porous supporting substrate.

9. The ceramic membrane of claim 8 wherein the porous substrate comprises a mixed metal oxide of formula:
Ln₁₋ₓSr_{y}Ca_{x-y}MO_{3-δ}
wherein Ln is selected from the f block lanthanides and yttrium; M is selected from the d block transition metals; 0.1≦x≦0.4; 0.01≦y≦0.25 and δ is a number that varies to maintain charge neutrality.

10. The ceramic membrane of claim 1 having a reduction surface and an oxidizing surface wherein the reduction surface is coated with a reduction catalyst.

11. The ceramic membrane of claim 1 having a reduction surface and an oxidizing surface wherein the oxidation surface is coated with an oxidation catalyst.

12. The ceramic membrane of claim 1 having an expansion coefficient of 10×10⁻⁶/° C. or less and a total synthesis gas production rate of at least about 10 ml/min-cm².

13. A catalytic membrane reactor containing the ceramic membrane of claim 1.

14. A method for production of synthesis gas by reaction of an oxygen-containing gas with a hydrocarbon which comprises the steps of:
(a) providing a catalytic membrane reactor cell comprising an oxidation zone and a reduction zone separated by a gas-impermeable ceramic membrane having a reduction surface and an oxidation surface wherein the membrane comprises an ionic- and electronic-conducting phase having the formula:
Ln₁₋ₓSr_{y}Ca_{x-y}MO_{3-δ}
wherein Ln is selected from the f block lanthanides and yttrium or mixtures thereof; M is selected from the d block transition metals or mixtures thereof; 0.1≦x≦0.4; 0.01≦y≦0.25 and δ is a number that varies to maintain charge neutrality.
(b) heating said reactor cell to a temperature of from about 300° C. to about 1200° C.;
(c) passing an oxygen-containing gas in contact with the reduction surface of said membrane of said heated reactor in said reduction zone; and
(d) passing a hydrocarbon gas in contact with the reduction surface of said membrane to effect the production of synthesis gas.

15. The method of claim 14 wherein in the mixed conducting membrane Ln is La or a mixture of La and Y.

16. The method of claim 14 wherein in the mixed conducting membrane M is Fe.

17. The method of claim 14 wherein in the mixed conducting membrane x does not equal y.

18. The method of claim 14 wherein in the mixed conducting membrane x is about 0.25.

19. A method for preparing a gas-impermeable membrane having an expansion coefficient less than 10×10⁻⁶/° C. and a total syngas production rate of at least about 10 ml/min-cm² and which comprises an ionic- and electronic-conducting material which method comprises the steps of:
a. admixing precursors of the metals Sr, Ca, Ln and M where Ln is selected from the f block lanthanides and yttrium or mixtures thereof and M is selected from the d block transition metals ior mixtures thereof in relative molar amounts according to the mixed metal oxide formula:
Ln₁₋ₓSr_{y}Ca_{x-y}MO_{3-δ}
where 0.1≦x≦0.4; 0.01≦y≦0.25;
b. milling the mixture to obtain a homogeneous powder;
c. calcining the milled powder at temperatures ranging from about 1100-1250° C. until the reaction is complete;
d. optionally mixing the calcined powder with a binder and pressing the powders isostatically to form a desired membrane shape;
e. sintering the shaped membrane in air at temperatures ranging from about 1100-1250° C. to form a dense membrane which is gas-impermeable.

20. The method of claim 19 wherein Ln is La or a mixture of La and Y and M is Fe.
